(19) United States
(12) Patent Application Publication
(10) Pub. No.: US 2017/0093777 A1
(43) Pub. Date: Mar. 30, 2017

(54) App for Selective Monitoring of Social Media Activity

(71) Applicants: Angela G. Neustifter, Carrollton, TX (US); Lisa Maria deLeon, Addison, TX (US)

(72) Inventors: Angela G. Neustifter, Carrollton, TX (US); Lisa Maria deLeon, Addison, TX (US)

(21) Appl. No.: 15/278,748

(22) Filed: Sep. 28, 2016

Related U.S. Application Data
(60) Provisional application No. 62/233,778, filed on Sep. 28, 2015.

(51) Int. Cl. H04L 12/58; H04L 29/08

(52) U.S. Cl. CPC H04L 51/16; H04L 51/32; H04L 67/306; H04L 67/22

(57) ABSTRACT

Apparatus and method for monitoring and following posts of selected individuals on a selected social media platform (SMP) or multiple SMPs directly from a users's personal wireless device without separately logging in to each social media platform. An App is provided for installation in a personal wireless device and configured to respond to the user's entry of icon-selectable commands on the touch-sensitive display screen to execute operative sequences performed by a processor in the wireless device to control synchronizing to the one or more SMPs, following the social media posts in the feeds of individuals across one or multiple SMPs, entering keywords to enable content searching and monitoring among the SMP feeds, and notification of keyword existence in individual feeds.

### CROSS REFERENCE TO RELATED APPLICATIONS

This application claims priority to U.S. Provisional Patent Application Ser. No. 62/233,778 filed Sep. 28, 2015 by the same inventors and entitled: APP FOR SOCIAL MEDIA MONITORING.

### BACKGROUND OF THE INVENTION

1. Field of the Invention

The present invention generally relates to functional applications installed on personal wireless devices such as smartphones and more particularly to applications for monitoring and following the posts of other users on selected social media platforms.

2. Background of the Invention and Description of the Prior Art

The functionality of the ubiquitous smart phone has been multiplied and enhanced far beyond what could have been imagined only a few years ago. While a number of social media aggregating programs have been written, many of them suffer from various encumbrances of use that render them less convenient than they otherwise could be. Others do not provide monitoring capabilities that are needed by parents and friends to follow children (e.g., to monitor circumstances of bullying or inappropriate use of language or particular feeds) or other users that could benefit from knowledge of the content of the posts of some individuals or the state of mind of friends (e.g., for posts containing messages or hints of depression, anxiety, etc.) of a user of the monitoring functions. For example, one important limitation of conventional social media platforms is the extraordinary amount of data to search through to locate a particular individual of interest.

Other similar applications are adapted to specific kinds of posts and lack the versatility needed to adapt the personal wireless device of a user to various monitoring and following needs. Trying to add features or to modify an application or “App” to a use that it was not designed to handle can be unproductive even if the structure of the App permits such modification.

What is needed is a mobile device application that solves the above deficiencies.

### SUMMARY OF THE INVENTION

Accordingly there is provided an apparatus for monitoring and following posts of selected individuals in the feeds of multiple social media platforms from a personal wireless device of a user, the device having a processor, a non-transitory memory, a wireless interface to a global communications network, and a touch-sensitive display screen for entry of user selections, comprising. The apparatus includes a program stored in the non-transitory memory and configured to respond to the user's entry of icon-selectable commands on the touch-sensitive display screen to control operative sequences executed by the processor in controlling, from within the program installed in the personal wireless device, operations including synchronizing the personal wireless device, using downloaded interfaces, with the multiple social media platforms to enable interactive access with and aggregation of all of the user's contacts across the social media platforms; choosing direct access to and interaction with a specified individual contact's feeds from each of, or from all feeds across the multiple social media platforms, for following or monitoring the individual feeds of specified individual contacts thereof; entry of keywords into a filtering sequence in the program for identifying content in contact's feeds being followed or monitored that is of potential interest to the user of the personal wireless device; and notification and highlighting of the occurrence of keywords in each social media feed of a contact followed or monitored from the personal wireless device.

In another aspect, the invention includes sequences of process steps, comprising: (1) synchronizing the program with one or more social media platforms using an application program interface (API) provided by each social media platform; (2) associating icon-initiated user commands displayed on the display screen of the user device with directing execution of the sequences of process steps; (3) entering search terms or keywords into a keyword file for retrieval and for controlling searching, notification, and highlighting of the search terms in feeds accessed by the program for display to the user, (4) enabling additions and deletions of keywords in the keyword file; (5) providing direct access and interaction with a specified social media platform or across the multiple social media platforms from within the program, for responding thereto or entering content; (6) providing display screens to display social media feeds of contacts, lists of keywords, lists of chosen contacts, and a keyboard for entering the search terms and chosen contacts; (7) updating user profile and account status information; and (8) providing a plurality of housekeeping functions accessible from a menu command.

In another embodiment, the invention comprises, in a personal wireless device comprising a processor, a non-transitory memory, a wireless interface to a global communications network, and a touch-sensitive display screen for entry of user selections, and having a program stored in the non-transitory memory and configured to respond to the user's entry of icon-selectable commands on the touch-sensitive display screen to control operative sequences performed by the processor, a method for following and monitoring posts of selected individuals on and across multiple social media platforms from a personal wireless device, comprising the steps of (1) selecting individual feeds from each of the selected social media platforms for monitoring and following posts of specific individual users thereof; (2) entering keywords into a filtering sequence in the program for identifying subject matter of potential interest to the user of the personal wireless device; (3) notifying and highlighting the occurrence of keywords in each social media feed of an individual selected to be monitored and followed from the personal wireless device; and (4) calling a sequence in the program to enable the user of the personal wireless device to be directed to a specific social media platform for replying to an individual being monitored or followed.

### BRIEF DESCRIPTION OF THE DRAWINGS

The following numbered figures include fifteen screen shots as they appear on a mobile phone such as a smart phone and one flow chart diagram of the processes performed in the App for Monitoring Social media described herein.

FIG. 1 illustrates a Home screen display of one embodiment of the invention as depicted in FIG. 19;

FIG. 2 illustrates a Signup/Login screen display of the embodiment of FIG. 1;

FIG. 3 illustrates a Synchronize screen display of the embodiment of FIG. 1;

FIG. 4 illustrates a Typical List of Feeds screen display of the embodiment of FIG. 1;

FIG. 5 illustrates an Add to List of Feeds screen display of the embodiment of FIG. 1;

FIG. 6 illustrates a Removing from List of Feeds screen display of the embodiment of FIG. 1;

FIG. 7 illustrates a Keyword List—Entry screen display of the embodiment of FIG. 1;

FIG. 8 illustrates a Keyword List screen display of the embodiment of FIG. 1;

FIG. 9 illustrates a Keyword List—Delete screen display of the embodiment of FIG. 1;

FIG. 10 illustrates a CHOOZ List of Feeds—All Platforms screen display of the embodiment of FIG. 1;

FIG. 11 illustrates a Example of Platform Feed—Social media #1 screen display of the embodiment of FIG. 1;

FIG. 12 illustrates a Example of Platform Feed—Social Media #2 screen display of the embodiment of FIG. 1;

FIG. 13 illustrates a Example of Platform feed—Social Media #3 screen display of the embodiment of FIG. 1;

FIG. 14 illustrates a Chooz Individual with Search Bar screen display of the embodiment of FIG. 1;

FIG. 15 illustrates a User Profile/Shop Select screen display of the embodiment of FIG. 1;

FIG. 16 illustrates a Profile Update screen display of the embodiment of FIG. 1;

FIG. 17 illustrates a Chooz Shop screen display of the embodiment of FIG. 1;

FIG. 18 illustrates a Sign Out screen display of the embodiment of FIG. 1; and

FIG. 19 illustrates a Functional Flow Chart Diagram screen display of one embodiment of the invention.

### DETAILED DESCRIPTION OF THE INVENTION

The present invention, an app called “CHOOZ” by the inventor, allows the user to monitor their contacts, including followers, friends, and family members' social media activity across selected multiple platforms. As is well known, the term “App” refers to an “Application”—which is a software program installed in a non-volatile memory of a smart phone or computing device that enables the device to perform a specific set of functions. This invention, an “App for Selective Monitoring of Social Media Activity” from a user's smartphone or other mobile device, or any other computing device in which the App is installed, is unique in that, once the user of the App is logged in, the user can filter and select the posts of individuals using any of several specific social media platforms (or, “SMPs”) that the user of the App wants to view (or monitor, follow, or track) based on any of the names of contacts or individuals (displayed in alphabetical order) posting content on the SMP.

The process of setting up an interface from the App to a particular SMP to gain access to the files and posts of its individual users from the user's smart phone (or other device) is the first of several unique features of the App called “synchronizing” to the SMP as will be described. A second unique feature of the App is the App allows the user to filter and select the posts he or she wants to view based on either the user's contacts (the person that posted) or the social media platform. The App also enables accessing their contact's posts through the SMPs individually or through an “All Feeds” selection. A third unique feature of the present invention is that the user of the App may view any file or post by an individual containing specific subject matter identified by a “keyword” previously entered into the App by its user. The utility of this important feature will become apparent in the following description.

In the novel “keyword” feature, the user can enter and call up any of an unlimited number of keywords that will be filtered and highlighted within the posts from an SMP that the user has chosen. The user is also given the option to receive notifications when those keywords are used during a social media activity being monitored. Further, the keywords are notified to the user of the App in the comments within a user's contact's feeds. These keyword capabilities enable the user to track the subject matter of the content in a social media post that is being monitored or followed. The App will also redirect the user to the specific platform where the post occurred so the user can view and/or respond from his or her smartphone—e.g., like, reply or comment while logged in to the CHOOZ App. This feature obviates the need for the user having to go separately to each social media platform to respond.

The subject matter of a post or comment to a post on a social media platform is often of concern, especially to parents or close friends, employers, the administration of educational institutions, etc. Thus, the entry of keywords into a filtering sequence in the App's program serves to identify content of potential interest to the user of the smartphone or other personal wireless device. Moreover, the Keyword feature provides for notification and highlighting of the occurrence of the keywords chosen by the user during the entry step in each social media feed of an individual selected to be monitored and followed from the user's device. In the embodiment to be described, the preferred user's device, because of its convenience, is assumed to be a personal wireless mobile device such as a smartphone. However, persons skilled in the art will understand that any computing device capable of utilizing the CHOOZ App is suitable.

Several terms that will be used in the following description are defined as follows. A social media platform (“SMP”) is an interactive, on-line social network that provides virtual communities for communicating and sharing content generated by users. Various examples of these social media platforms will be designated generically as SM₁ (first social media or social media #1), SM₂ (second social media or social media #2), SM₃ (third social media or social media #3) . . . SMₙ (nth social media or social media #n), where the numeric subscript represents a distinct individual social media platform, service, or site. The corresponding icons for these platforms appear in the figures as the initials SMₙ enclosed within a rectangle. The social media platforms or SMPs that may be interfaced by the App are those that permit third party access upon obtaining permission and agreeing to the terms and conditions of use of the API (Application Program Interface) provided by the social media platform of interest when the user downloads the App. The illustrated example of the App described herein provides such interface access to three social media platforms. The App is not intrinsically limited to three SMPs, hence the generic icon SMPₙ, where the subscript “n” denotes the number of SMPs that are interfaced from a particular user's mobile device. In the description to follow, the illustrated example is described for an App that handles three SMPs. However, the invention is not limited to three SMPs—other numbers are possible. As understood by persons skilled in the art, because the data that may be accessed and processed by each SMP is likely very large, that factor alone may be considered as a limiting factor in the number of platforms that may be managed by the present invention.

Several other definitions related to icons or terms displayed on the screen of the user device as depicted in the accompanying figures should be helpful in this description. In specific embodiments, buttons at the top or bottom of the display screen, or other features of the display, may be colored for distinctiveness when they are selected or active; buttons that are idle may be uncolored. The icons for social media platforms available in the App—here as examples SM₁, SM₂, and SM₃—are generally placed along the left-hand margin within a colored (bold) circle. A circle (not bold) around the icon of a social media platform (SMP) may be used to indicate it is selected. A colored eye or eyeball icon on the same line as a name, to signify “watching,” indicates that an individual name is selected. A “feed” refers to a post on a social media platform. A switch in some screenshots is depicted as a horizontal oval icon with a circle within its border. When the circle is positioned (i.e., swiped by the user) to the left, the function is OFF or unselected; when the circle is positioned to the right, the function is ON or selected, and the space to the left of the circle may be highlighted by shading or colored-in.

In other definitions, a “keyword” identifies subject matter of interest in a SMP post. A “contact” refers to an individual posting a feed on a SMP that the user of the App wishes to follow, monitor, or visit. Most of the functional screen displays are identified at the top center of the display by a single term, such as Synchronize, the name of a social media platform, Keywords, Chooz list, Profile, etc. On some screen displays, a check mark (✓) appears to indicate “process completed” and an (X) mark appears to indicate that a name or keyword may be deleted. The “arrow” symbol (>) appearing to the right of a name in a list on the screen, when tapped, takes the user to a related screen displaying the contact's feeds. The term “CHOOZ” is the name given to the App. This term also refers to the icon that represents the App containing the present invention as described herein.

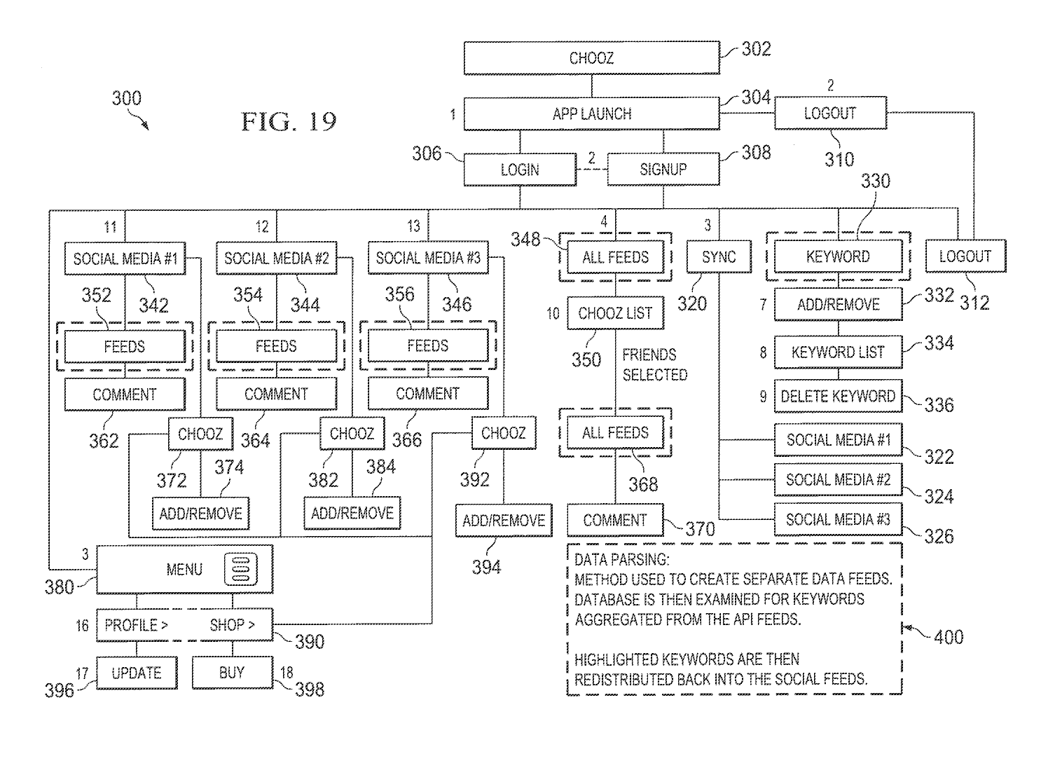

The foregoing introduction provides an overview of the principle features of the present invention. In the following detailed description of a preferred embodiment, information is provided to enable a programmer of ordinary skill in the art to construct the necessary software to perform the processes described and illustrated in the accompanying figures. The App is referred to generally as App 300 (See FIG. 19). The App 300 in this illustrated example may be implemented on a typical smartphone device 10 as shown in the Figures, with certain features of the App 300 depicted on the touch-sensitive screen 12 of the smartphone device 10 as will be described. Reference numbers appearing in more than one figure refer to the same structural element or feature.

Proceeding to the detailed description, a principal initial consideration is that the user can choose the view of a social media post in three ways:

(1) By platform: the user, in this exemplary embodiment, has the option of sorting posts by SM₁, SM₂, and SM₃. All of the chosen posts will appear in that platform's feed by selecting SM₁, SM₂, or SM₃.
(2) By the user: the user chooses the contacts he or she wants to monitor within the App 300. Further, there is an “All Feeds” Option to enable the App to display posts for any desired contact across ALL platforms that are synchronized in the App 300.
(3) By Keywords: the CHOOZ App allows users to program a set of keywords for the App 300 to monitor. As the user scans through the posts, the keywords are highlighted on the display for quick reference.

Thus the CHOOZ App 300 can be much more versatile than just a tool of convenience. Other important uses can include, without limitation: (A) as an aid in preventing on-line bullying; (B) limiting participation in inappropriate online activities; \textcircled{c} giving parents the means to observe the interactions that their children have with other people on social media, including enabling parents to see all of their child's social media activity on the chosen platforms; (D) allowing parents to know when and observe if the child is using inappropriate language; and (E) to know whether their child shows signs of depression, anxiety, suicidal thoughts or any other of the many concerns regarding their child's use of social media. For example, one useful role of the CHOOZ App 300 in this context is that a portion of the proceeds from each download may be donated to the National Bullying Prevention Center on PACER (Public Access To Court Electronic Records) at www.pacer.gov. The National Bullying Prevention Center at www.pacer.org/bullying provides resources for prevention of and responding to instances of bullying. The App 300 may also be used by friends and family members interested generally in the well-being of another person.

Many other uses exist for the CHOOZ App 300. It can be used to monitor an on-line presence for employees; for monitoring students, for communicating with parents about campus emergency situations; for law enforcement such as monitoring criminal activity that may be taking place on social media; for keeping track of athletic recruits in both the collegiate and professional categories; and developing special “enterprise” or corporate pricing suited to particular needs.

The invention as illustrated herein is designed to be used on a smartphone 10 or other personal wireless mobile device having a touchscreen display 12 for interacting with the device to make selections, enter information, advance to a next screen or return to a previous screen, all operations that are well-known to present users of such devices. For example, such devices typically have the capability to respond to the user's touch or swipe action as a way of entering a command. Accordingly, the personal wireless device includes at least a processor, a non-transitory memory, a wireless interface to a global communications network, and a touch-sensitive display screen for entry of user selections; and a program application (such as the “App 300”) stored in the non-transitory memory and configured to respond to the user's entry of icon-selectable commands on the touch-sensitive display screen to control operative sequences performed by the processor.

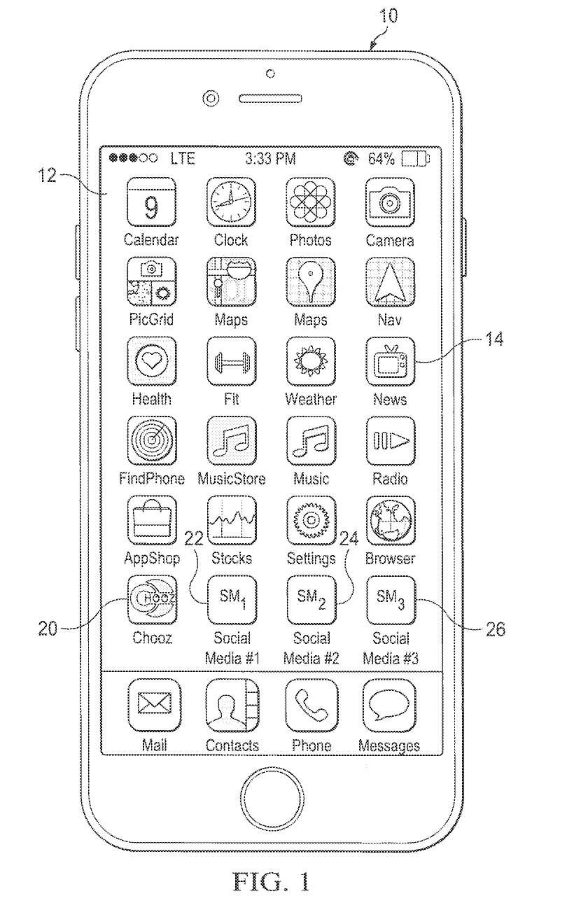

The accompanying functional flow chart drawing (FIG. 19) and the series of numbered screenshots (FIGS. 1-18) provide an illustration of the system operation and how the invention process appears to a user. The functional flow chart 19 includes numbers (above or to the left of the functional block) that relate some of the steps (identified in the functional blocks) to a particular screenshot figure. The dashed lines surrounding certain blocks in FIG. 19 designate certain unique features—such as the SMP “feeds” and “keyword” features—of the present invention as compared with conventional social aggregating programs. These features enable the App 300 to provide selective monitoring of the feeds from a set of social media platforms whose access is interfaced from the App 300, feeds that may be selected by the user based on the names of individuals in the posts as well as keywords entered by the user into a database. This selectivity, through a filtering process, enhances the efficiency of the monitoring function as directed by the user of the App 300. This efficiency not only reduces the time to locate and monitor specific individual posts but also provides the capability to identify specific subject matter of interest or concern to the user that may be present in the posts selected for monitoring. This capability, which substantially improves the ability of personal mobile devices (and other computing devices) to monitor social media posts across multiple platforms directly from the user's mobile device without having to separately log in to the SMP of interest, is a technical improvement in the state of the art heretofore not available in social media aggregating applications. Another technical improvement is the ability to search all synchronized SMPs for posts containing specific keywords that may indicate posts of specific interest to the user who wishes to monitor or follow posts of a child or other person who may be at risk of harm, for example.

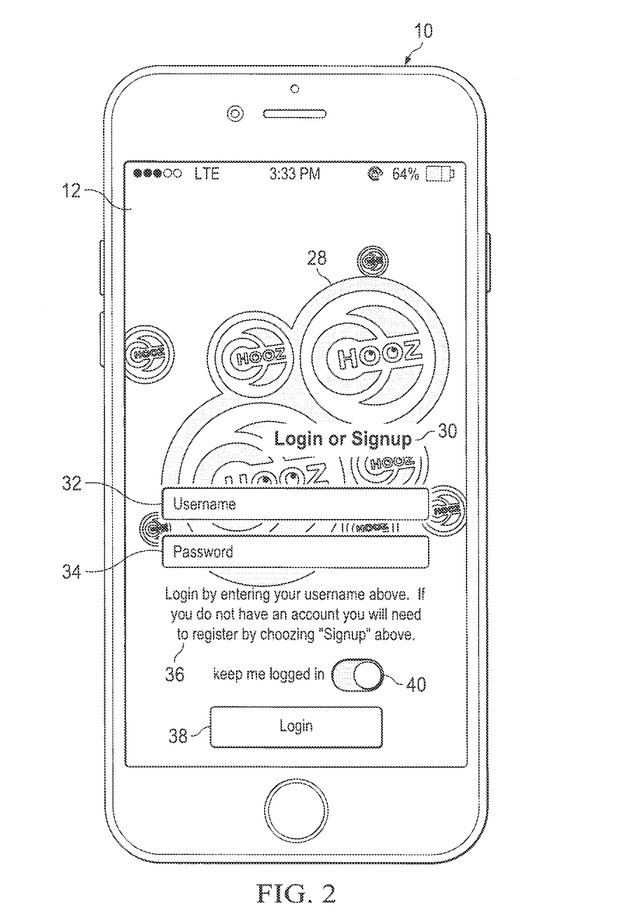

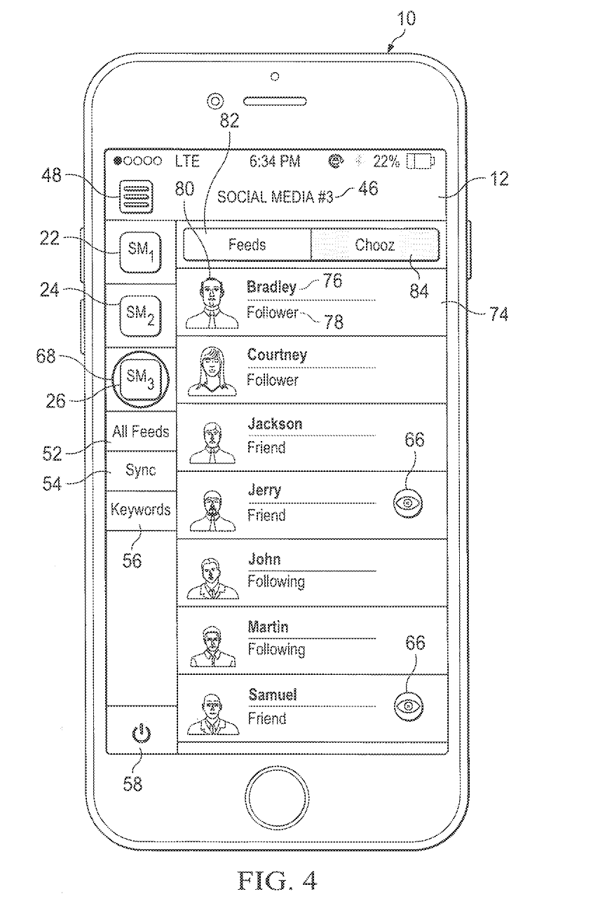

The series of numbered screen shots (FIGS. 1-18) and the functional flow chart diagram (FIG. 19) are described in the following material. Note that for each principal screen shot of the CHOOZ App 300, a title of the particular screen shot appears at the top of the display. While the drawings do not depict colors, the titles and other features may be shown in colored text, icons, or other depictions. This notation does not appear on the home screen (FIG. 1) or the signup/login screen (FIG. 2). Each screenshot illustrates a function of the App 300 as it relates to the user, either for logging in, synchronizing to SMPs, entering or deleting names or keywords, updating profiles, viewing information, etc. The screenshots of FIGS. 4 through 14 depict the principal features of the invention. Note that each of these includes a “Menu” icon (48)—a white square with three horizontal lines—at an upper corner of the screen. The uses of the Menu icon 48 will be described below.

FIG. 1 illustrates a Home screen display of one embodiment of the invention as depicted in FIG. 19. The Home screen shown on the display 12 depicts an array of icons representing links to applications (“Apps”) stored in or available to the user device 10 for use by touching the respective icon. The icon 20 in the bottom row and left-hand column, just above the basic icons in the most bottom row, is provided to select the “CHOOZ” App 300 (after it has been installed), which is the subject of the present description. In this example, the icons for social media SM₁ (22), SM₂ (24) and SM₃ (26) that may be accessed from within the CHOOZ App 300 (after they have been “synchronized” or “synced”) are shown in the same row to the right of the CHOOZ icon 20.

FIG. 2 illustrates a Signup/Login screen display of the embodiment of FIG. 1. After the App 300 has been downloaded from a supplier and installed, this screen depicts the display that appears on selection of the CHOOZ icon 20 on the home screen, which is shown in greater detail in FIG. 2 as the CHOOZ icon 28, including prompts to follow the Login or Signup procedure 30 and enter the requested username 32 and password 34 according to the displayed instructions 36. A Login button 38 is provided to initiate the login process and the circle in the button switch icon 40 may be positioned to the right to indicate “Keep me logged in.” If it is desired to log out, the user may swipe the circle in the oval to the left.

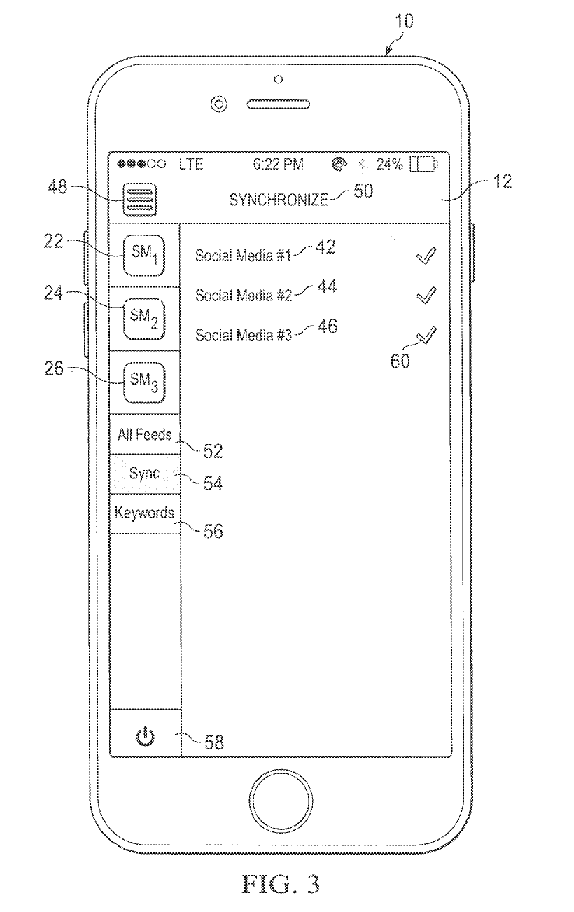

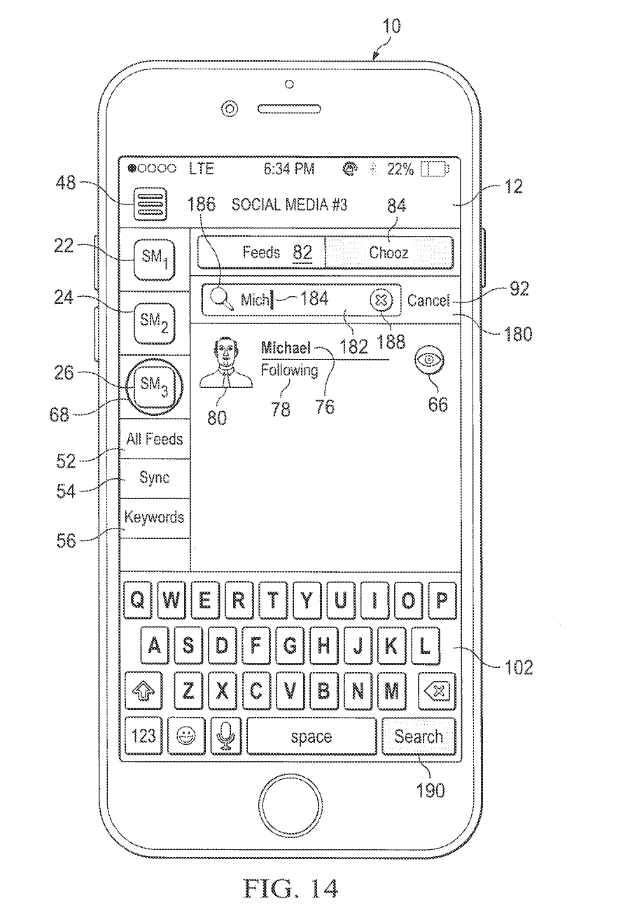

FIG. 3 illustrates a Synchronize screen display of the embodiment of FIG. 1. The basic arrangement of the CHOOZ App 300 screen display 12 appears in FIG. 3, which places control icons or buttons along the left margin. For example, the uppermost icon shown is Menu 48 (white square with three horizontal colored lines) that when touched brings a menu of options to the screen for the user to select. One of the options, for example, is to transfer the user to a screen that presents two administrative choices—Profile or Shop—on the screen at FIG. 14. Following the left side margin downward, respective icons 22, 24 and 26 appear for the social media platforms SM₁, SM₂, and SM₃. Buttons labeled “All Feeds 52,” “Sync 54” and “Keywords 56” are arrayed along the left side of the screen 12. At the bottom of the left margin is a split circle with a short line positioned within the split. This split circle 58, when tapped, is used to enable the user to sign out of the App or cancel an action. A list of the social media platforms, here SM₁, SM₂, and SM₃, respectively 42, 44 and 46, appears on the display 12 to the right of the corresponding icons 22, 24 and 26. These represent the social media platforms that may be interfaced from the App 300 and confirms their availability for access with a check mark 60 (✓), on the same line as their icons displayed along the left side of the screen. Each SMP icon 22, 24 and 26, here a symbol within a rectangular border, may be high-lighted by a colored circle or by some other indicator when it is separately accessed from the App 300.

When the SYNC button 54 in the left margin is touched, the App 300 aggregates all of the feeds from each social media platform SMₙ from those followed by the user or that the user is friends with that have been set up when the App 300 is installed. The information feeds (noun usage here) on or from the SMPs may be stored in a cloud server. Once each SMₙ is synchronized with the CHOOZ App 300, the user can view all of the user's contacts across all synced (synchronized) platforms in a list of feeds as illustrated in FIG. 4 to be described.

The SYNC function, which initiates execution of the API interface provided in the CHOOZ App 300 upon installation, is typically used in four circumstances. It may be used (A) when the user initially downloads and sets up the account to install and use the CHOOZ App 300; (B) when the user chooses who he or she wants to monitor by touching an eyeball icon 66; \textcircled{c} after the user changes who he or she wants to monitor (i.e., wants to add or delete a name); and (D) any time the user logs out and back in to the account. The procedure is as follows: touch the SYNC button 54, then touch the icon for whatever SMₙ is to be synchronized. A turning wheel icon (not shown) may appear to indicate synchronization is in process, and a checkmark 60 (✓) appears indicating that the process is completed. In some embodiments, the synchronization may occur automatically; in others the user is advised to touch the SYNC button 54 with each of the above actions.

Once synching is complete, the user may simply tap on the SMP's icon to log in to that particular platform to post comments, etc. from within the CHOOZ App 300. In the illustrated embodiment this may be a one time function upon set-up unless the user logs out.

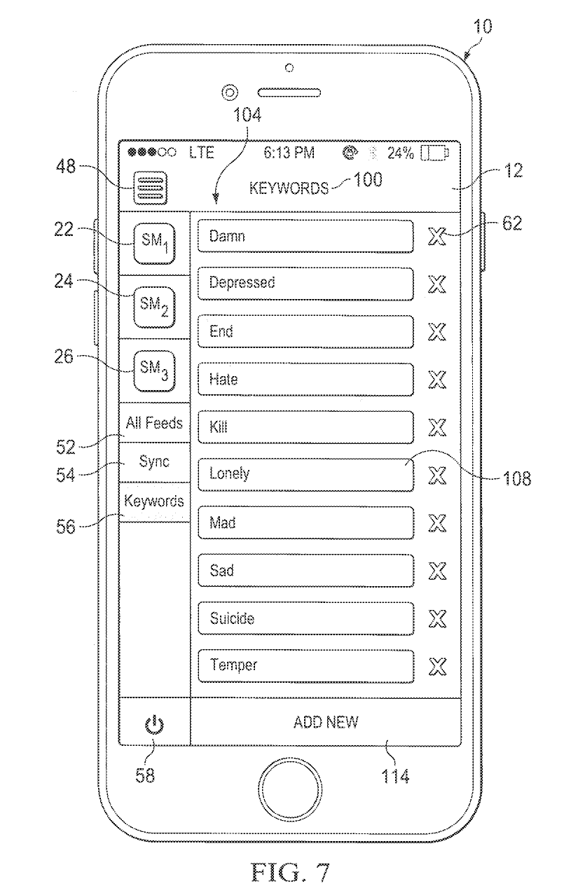

The All Feeds button 52, when touched, causes the CHOOZ App 300 to follow all feeds for each person you have chosen to follow. The Keywords button 56, when touched, transports the user to the screen display shown in FIG. 7 to be described.

FIG. 4 illustrates a Typical “List of Feeds” screen display of the embodiment of FIG. 1 for one of the social media platforms, social media #3 (46) as shown at the top of the display screen 12. The display screen 12 includes an alphabetized list of the names of individuals participating on one of the particular platforms (here, SM₃) accessed during the synchronization. Each name space 74 in the list includes an individual's name 76, a term indicating relationship 78 to the user of the App 10, and a photo 80 or other image of the individual when available. In FIG. 4, a portrait of Bradley, a follower is shown. The relationship may be stated as, for example, friend, family or follower. The SM₃ icon 26 of the selected social media platform is highlighted by a circle 68 to indicate that SM₃ 26 feeds are listed. If the user wishes to view contacts on one of the other SMPs, it is only necessary to touch the corresponding button—SMₜ (22) or SM₂ (24)—to advance to a screen display for the selected SMP as shown in FIG. 4. The identity of the selected SMP is displayed at the top of the screen as “Social Media #3” 46 as indicated by a circle around the icon.

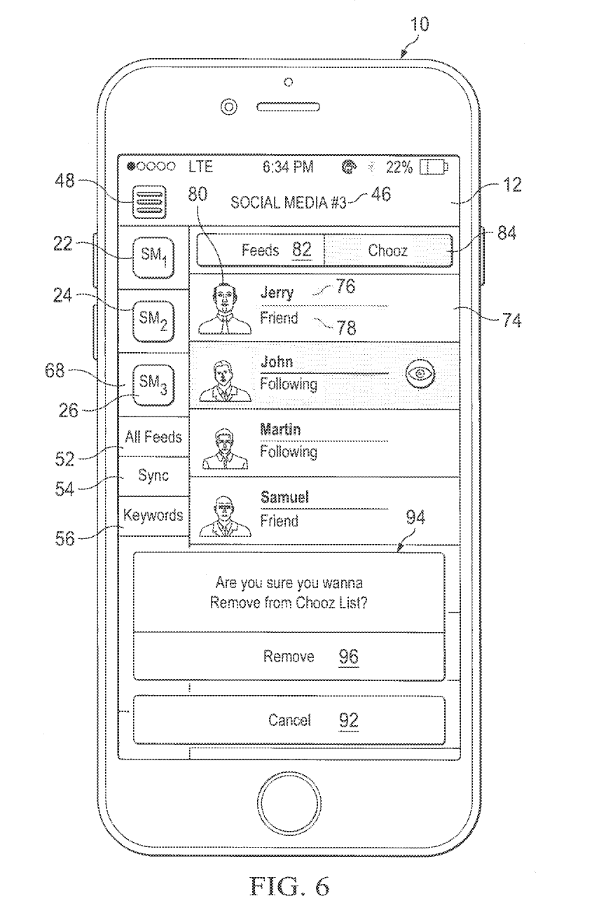

The eyeball icon 66, which may be colored to emphasize its appearance next to certain names, indicates who the user has chosen to follow or monitor via the App 300. When the user selects a name, by touching the name in the displayed list, the colored eyeball appears on the same line. If the user wishes to deselect that name, the user touches the name or the colored eyeball associated with the name, and a query panel (See FIG. 6) appears on the screen asking whether the user wishes to “Remove” the name or “Cancel” the opportunity to remove the name.

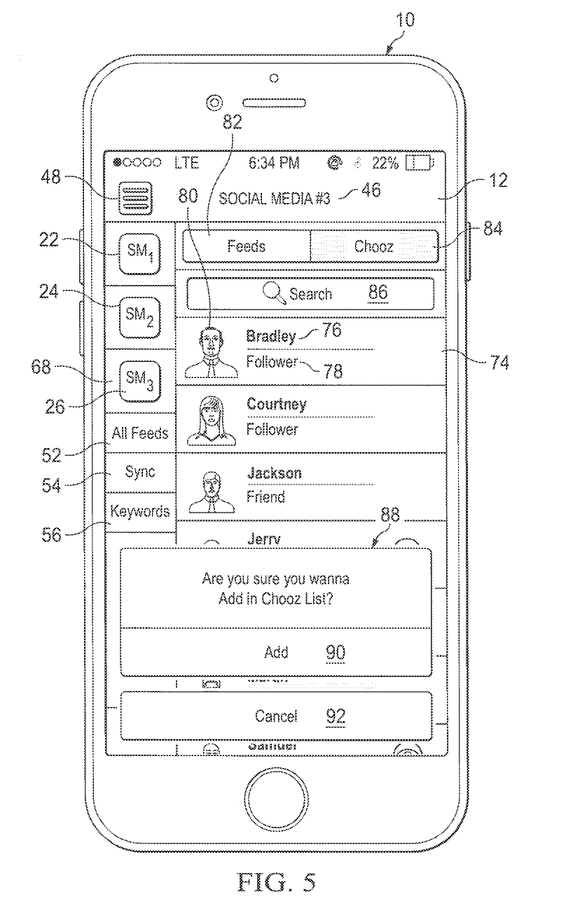

FIGS. 4, 5 and 6 are functionally related as will now be described. Beginning with FIG. 4, just above the uppermost name space 74 are a “Feeds” button 82 and a “Chooz” button 84. Touching or tapping the Feeds button 82 displays the list of social media platforms that are synchronized with the App 300. Tapping the Chooz button 84 displays the list of the user's contacts, in alphabetical order, from which the user can choose the type of user's relationship with the contact—e.g., follower, friend, or family. The “Feeds” button 82 and the “Chooz” button 84 may be toggled back and forth to see the feeds or list of contacts, for example when it is desired to add/delete a name from the list of contacts. After touching the Chooz button 84 to display a list of contacts, the user may scroll through the list (or press the Search bar 86) to select who the user wants to follow. Once the user taps the contact's name (to follow) on FIG. 4, the screen switches to FIG. 5 so the user may “Add” that contact's name. Touching “Add” on the displayed FIG. 5 confirms the selection by the appearance of a colored eyeball on the same line as the contact's name. If the user decides to “unchooz” a name, the user touches or taps the name indicated by the colored eyeball and the screen switches to FIG. 6 to provide for deleting the contact's name. Tapping the Remove term on FIG. 6 will remove the contact name from the Chooz list.

FIG. 5 illustrates a screen display to Add to the list of feeds. Similar to FIG. 4, this screenshot includes a query panel 88 stating a question “Are you sure you wanna Add in Chooz List?” and an Add icon 90, which may be a name of a contact, a word or a symbol. Below the Add icon 90 is a Cancel icon 92 in case the user decides not to add a name, word or symbol. Similarly, FIG. 6 illustrates a screen display to Remove a name from a list of feeds. Similar to FIG. 4, this screenshot includes a query panel 94 stating a question “Are you sure you wanna Remove from Chooz List?” and a Remove icon 96, which may be a word or a symbol. Below the Remove icon 96 is a Cancel icon 92 in case the user decides not to remove a name.

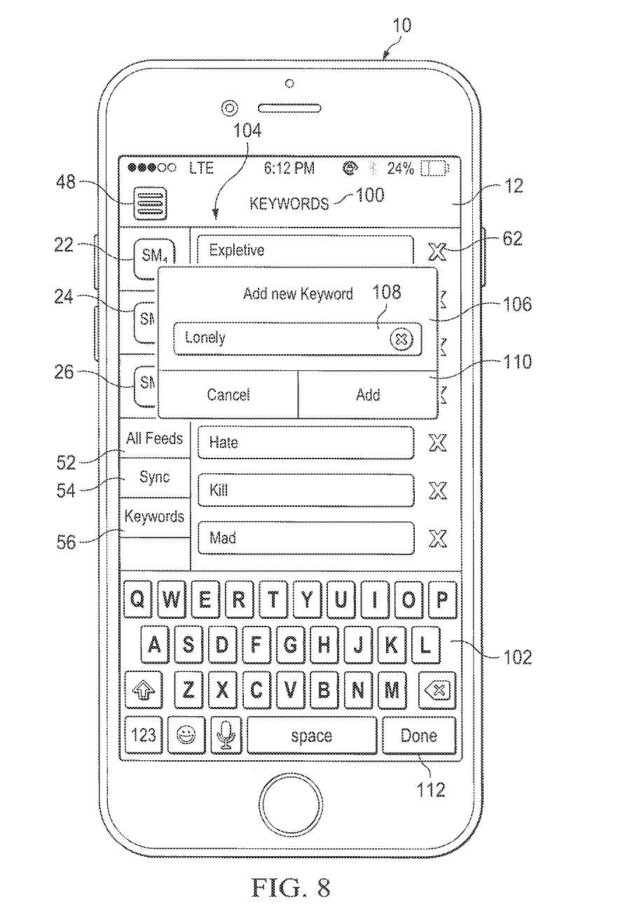

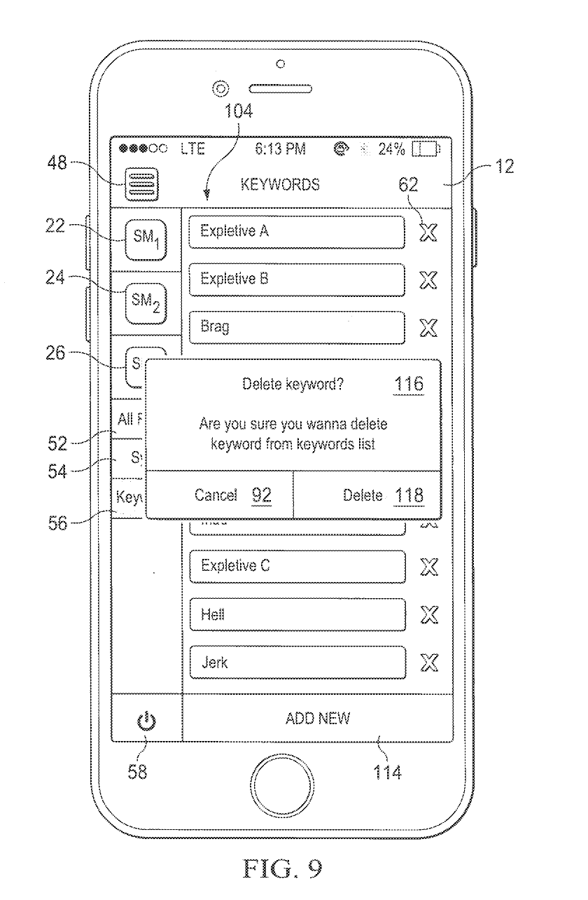

FIG. 7 illustrates a Keywords List Screen that displays an alphabetical list of the keywords 104 entered by the user. Each keyword 104 is enclosed in an outlined space 108. The screen in FIG. 7 includes an “Add New” link 114 at the bottom of the screen 12 to add a new keyword 104, which switches the screen display 12 to the screen depicted in FIG. 8. If the user wishes to delete a keyword, tapping the “X” Mark to the right of the keyword 104 switches the screen to FIG. 9 which pops up a Delete Keyword panel 116 that includes options to delete the selected keyword 104 at the Delete Term 118 or cancel the keyword function at the word “Cancel” 92.

FIG. 8 illustrates a Keyword Entry screen display that includes a QWERTY keyboard 102 for entering a new keyword 104. The Keywords screen 100 is accessed by touching the Keywords button or icon 56 on the screen. When the Keywords screen 100 appears, the word Keywords appears in the upper portion of the screen 12 and a pop up panel 106 appears superimposed over the list 104 of keywords displayed in the listing on the screen 12. The pop-up panel 106 includes a space for entering the keyword the user desires to enter. In the example shown, the word “lonely” is entered in the space 108. The space 108 includes the “X” Mark to allow the keyword 104 to be deleted. A keyword 104 may also be used as a search term in any feed or post being followed or monitored. A further space 110 includes the legends “Cancel” and “Add” for carrying out the next step to cancel the keywords operation or proceed to add a new keyword. In another example, if the user wishes to determine if a child is visiting an inappropriate website, a term representing the inappropriate subject matter may be entered, and the user notified whenever that term appears in the (child) users's feed on one of the three platforms. In another example, the feed of a friend being followed or monitored that contains a keyword entered by the user may initiate a notification to the user of a state of mind—e.g., lonely, depressed, anxious, or exhibiting suicidal thoughts—if the keyword occurs in the monitored person's feed. When the user's use of the keyboard 102 is completed, the user may touch the “Done” button to exit the keyword entry sequence.

FIG. 9 illustrates a Keyword screen 100 that includes a Delete Keyword panel 116 with a query “Do you want to delete a keyword from the keywords list?” Touching the Delete term or icon will accomplish the requested action. Touching the Cancel term or icon 92 may be used when the user decides not to delete a keyword.

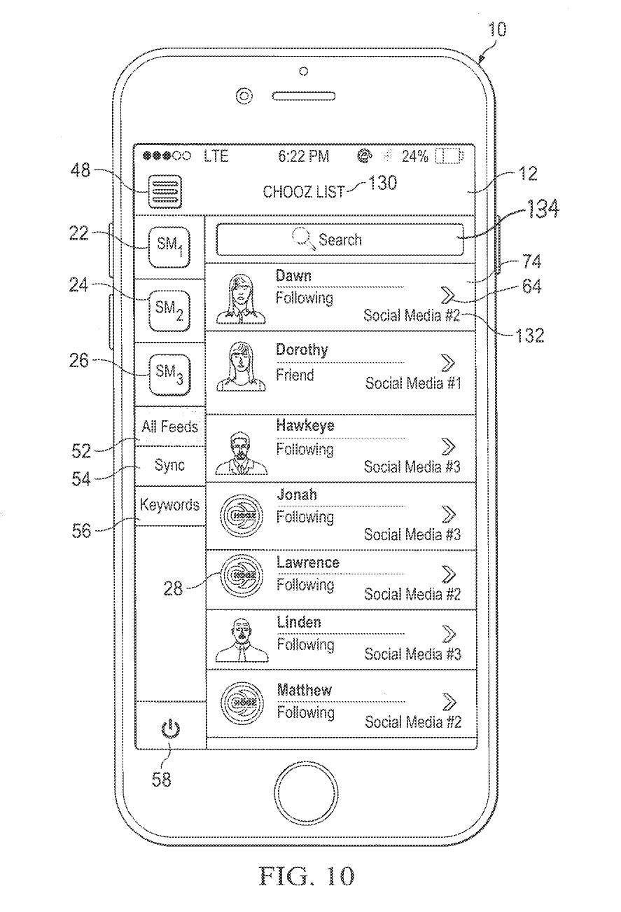

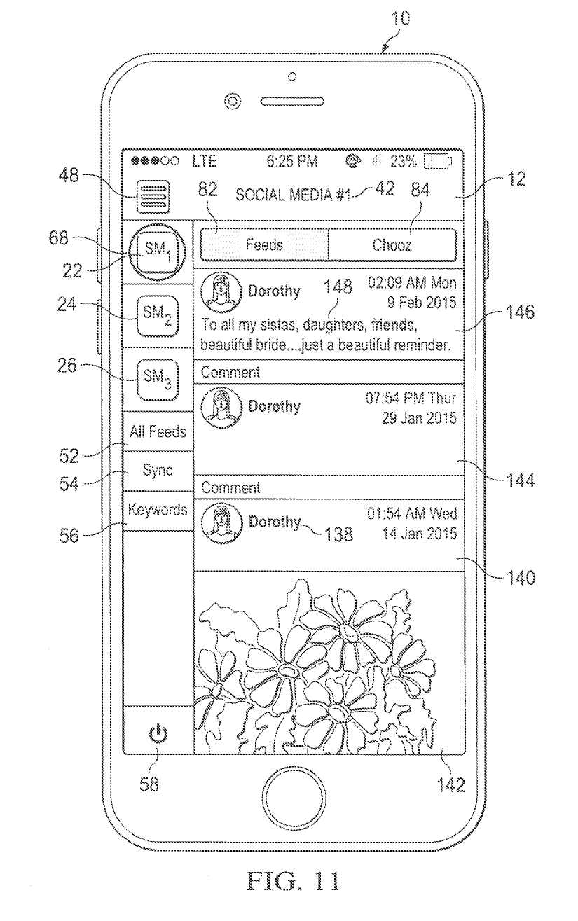

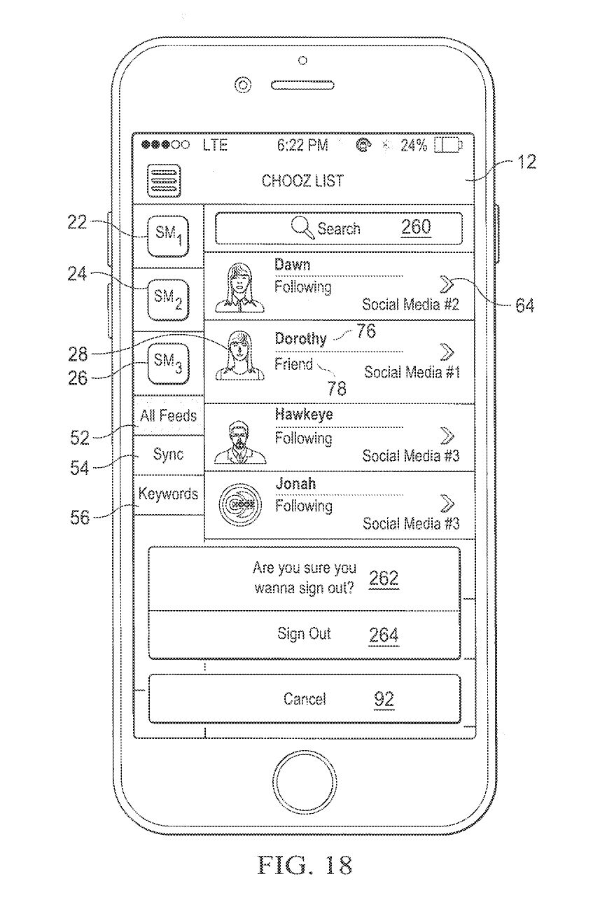

FIG. 10 illustrates a CHOOZ List 130 of Feeds that appears when the “All Feeds” button is tapped to display a list of the names of the individuals chosen to be followed or monitored (or other categories of users), identified by both the individual's name and the platform they are using, including the CHOOZ App 10 as represented by the CHOOZ logo 28. A Search Bar 134 appears above the first (uppermost) contact name 74 in the Chooz List 130. The Search Bar 134 is provided to locate with ease a user's contacts. To the right of each name is an arrow symbol > that when tapped takes the user to the feeds of that contact on the SMP noted in the CHOOZ list of FIG. 10. This same function is operable in the context of the sign-out routine illustrated in FIG. 18. FIG. 11 illustrates an Example of a Platform Feed for the Social media #1 screen display.

The icon for the selected platform is shown with the SM₁ icon surrounded by a circle 68. This display is a list of all of the users that are on the SM₁ platform 42 and the text 148 of their feeds 146 The list shown includes three feeds by an individual named Dorothy 138, with one feed 140 accompanied by an image of flowers 142, a feed 144 having no text message, and a feed 146 with text and with the keyword 100 “end” entered in the App shown in high lighted text in the particular message. Notice that the keyword “end” may be highlighted as used alone or when embedded within another word (e.g., “friends”) as shown in FIG. 11 where it is highlighted in boldface type.

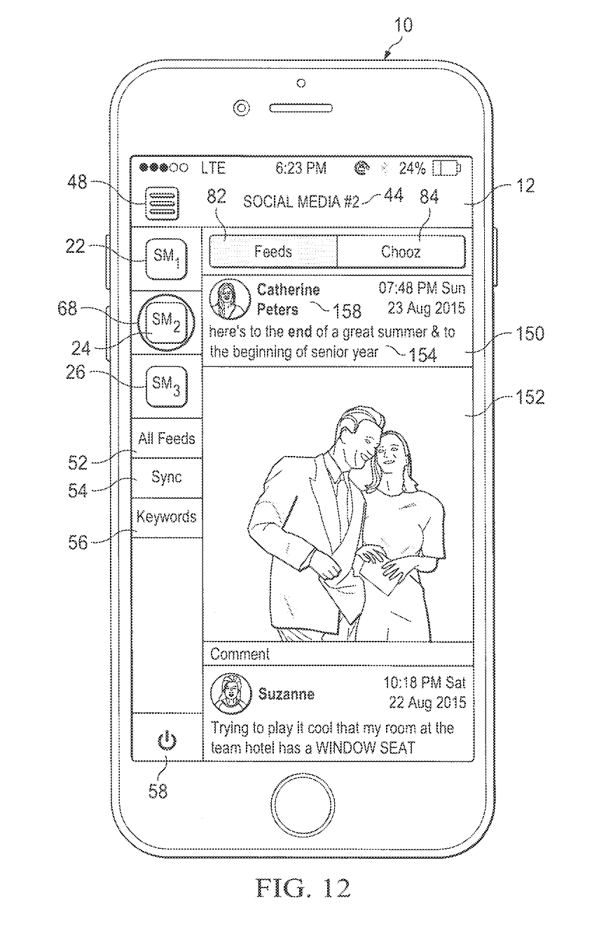

FIG. 12 illustrates an Example of a Platform Feed for the Social Media #2 screen display. The icon for the selected platform is shown with the SM₂ icon surrounded by a circle 68. This display provides a list of all of the users that are on the SM₂ platform, with any keyword entered in the App shown in highlighted text in the particular message. In this example, the feed 150 from Catherine 158 includes text 154 and a photo 152 that is embedded in or attached to the SM₂ message.

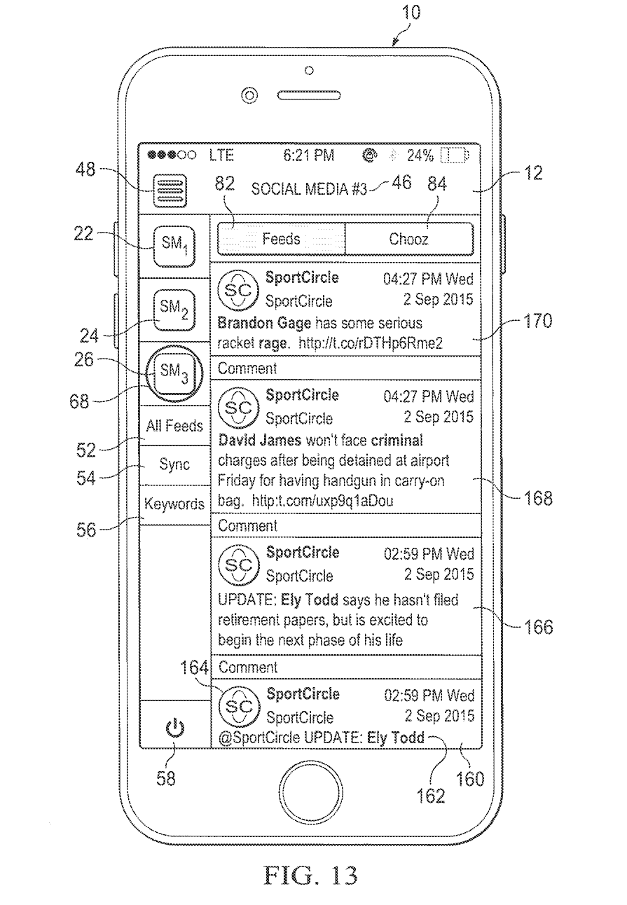

FIG. 13 illustrates a Example of Platform feed—Social Media #3 screen display. The icon for the selected platform is shown with the SM₃ icon surrounded by a circle 68. This display is a list of all of the users that are on the SM₃ platform, with any keyword 100 entered in the App 300 shown in highlighted text in the particular message. The feeds 160, 166, 168 and 170 depicted in FIG. 13 are not from an individual user but a service provider such as “SportCircle,” whose “updates” 162 are denoted by an icon 164 of its initials SC intersected by an ellipse and enclosed by a circle.

FIG. 14 illustrates a feed 182 from a person named “Michael” in the social media platform #3 after the bar 84 was tapped. The name Michael 184, a search icon 186 and a cancel icon X 188 appear in the same space 182 with the name 184. A search bar 190 appears with a keyboard 102 to allow the user to enter and locate a particular user's contacts. The following three screens (15, 16, 17) are another subset of the ones described above.

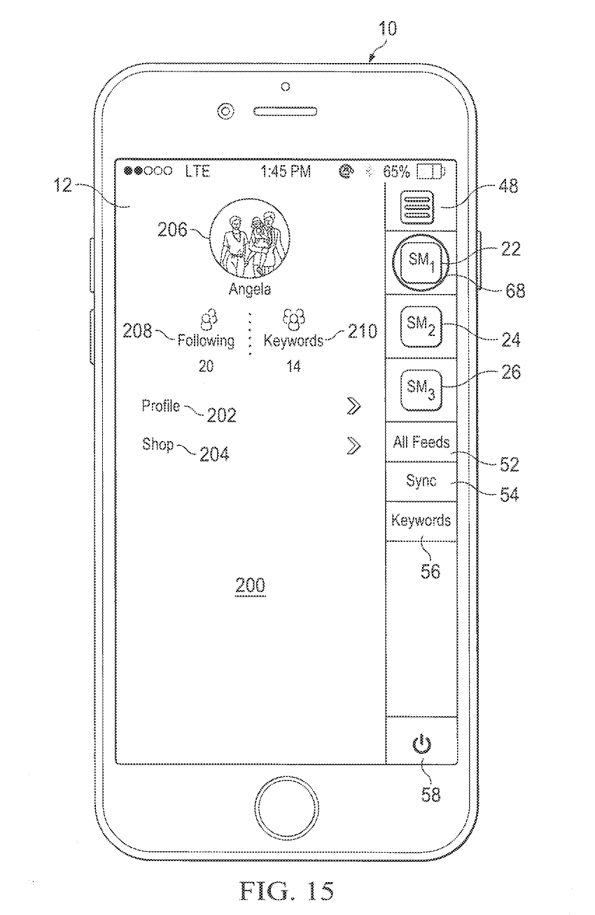

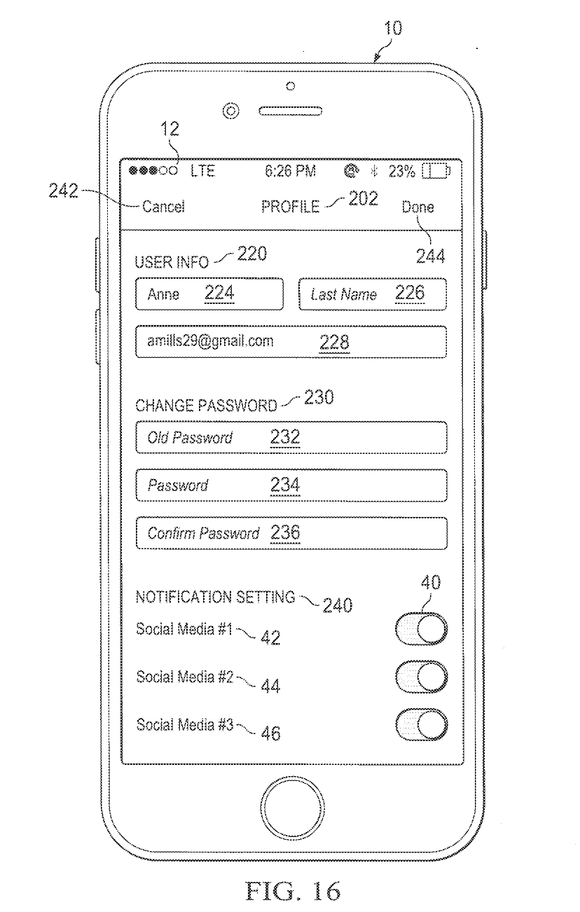

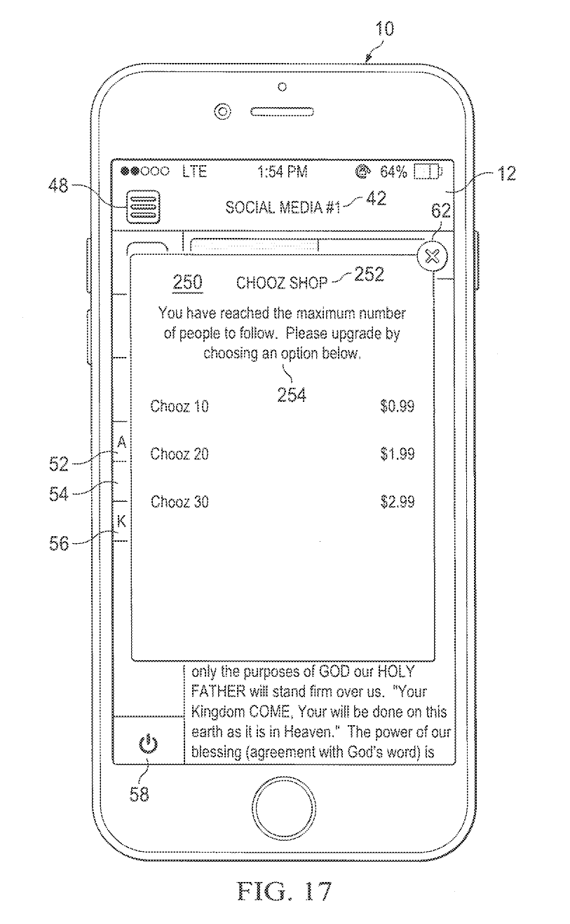

These screens, in this example, are associated with the portion of the flow chart diagram illustrated in FIG. 19 at the lower left of that diagram. This subset of FIG. 19 illustrates one sequence of the use of the “Menu” icon 48 that appears in most of the screens illustrated herein. When the user taps the menu icon 48 appearing on any screen, it opens to the user profile screen 200 shown in FIG. 15, to provide the user a path to select “Profile” update 202 or “Shop” update 204. The arrow symbols > indicate that tapping the term “Profile” takes the user to their profile and notification screen at FIG. 16; and tapping the term “Shop” takes the user to a screen at FIG. 17 to enable the purchase of more contacts. The user profile screen 200 may include the user's photo 206 and two lists 208 and 210. The list 208 may include a tally of the number of contacts or persons the user is following using the App 300. It may also include a tally of the number of keywords 210 entered into the App 300. The menu icon 48 that appears in the lower left portion of FIG. 19 graphically depicts the process flow of this subset associated with the menu icon for servicing the user's account in the App 300. Again, this subset is intended to be exemplary and not limiting to the particular functions depicted.

To summarize this example of the use of the Menu icon in this subset, it can be restated as follows: tapping or touching the Menu icon 48 is followed by the User Profile screen 200 that has the words “Profile” 202 and “Shop” 204 in the display. Then, tapping or touching “Profile” 208 takes the user to the user's Profile depicted in FIG. 16 that allows the user to “Update” his or her information. Alternatively, touching “Shop” 204 on the menu icon 48 is followed by the “Chooz Shop” panel 252 to select an upgrade option. The upgrade choices are based on the number of people to follow and the price to be charged for each upgrade option.

FIG. 16 illustrates a Profile Update screen 202, which displays the profile of the user of the CHOOZ App 300, including user info 222 such as first 224 and last 226 names, an email address 228, and password information. The spaces for password information include “Change Password” 230, Old Password 232, Password 234, and Confirm Password 236. The Notification Setting portion of the screen is set by the position of the circle within a button switch icon 40 located on the same line as the SMP button. Swiping the circle in the button switch icon 40 opposite the platform name 42, 44, or 46 to the right selects “Notification.” Swiping the circle in the button switch icon 40 to the left deselects “Notification” for the corresponding platform. In FIG. 16, all three SMPs are shown “selected” for notifying the user of keywords in the corresponding feeds.

FIG. 17 illustrates a pop-up panel 250 that depicts a CHOOZ Shop screen 252 display notify the user of the need to upgrade the number of feeds permitted by the provider of the App 300 as previously installed. The CHOOZ shop panel 250 provides options for upgrading optional features of the App, such as the number of people's names for the App 300 to follow or monitor. For example, on the social media #1 platform feed 42, the user is notified by the statement 254 that the number of feeds needs to be upgraded to one of the listed levels. The list may include the cost of the upgraded service as shown in the example of FIG. 17. A close-out button 62 with an “X” Mark is provided to close the panel 250 when the upgrade is completed. Other options may occur to persons skilled in the art.

One symbol appearing in each functional screen of the App is the split circle with a short line positioned within the split, also called a “split circle” 58. This symbol or icon appears most often in the lower left corner of each screen display and is provided to enable the user to sign out of the App or cancel an action from any screen. Regarding FIG. 18, another option made available to the user from either the menu icon 48 or the split circle 58 on any screen is to jump to a “Sign Out” display as depicted in FIG. 18. For example on a Chooz List 130 depicted in FIG. 10 is the option to sign out from the App 300. By tapping the icons 48 or 52 the user is presented with a sign out option 262, which can be selected by tapping the “Sign Out” term 264 or canceling the option by tapping the “Cancel” term 92 in the option panel 262.

FIG. 19 illustrates a Functional Flow Chart Diagram of the App 300 that depicts the flow of the principle functions of the App 300 and how they are organized. Each functional block is identified near its left end in the figure with a numeral (written as (#X) that corresponds to the Figure number of one of the screen displays. In this illustration, these principal functional blocks or steps correspond with FIGS. 4, 8, 10, 11, 12, and 13. #4 takes the user to the “All Feeds” subset so the user can proceed to select one of the three main Feeds, SM₁, SM₂, or SM₃. #8, accessed at the screen shown in FIG. 5 allows the user to add or cancel keywords to be monitored in the feeds. #10 brings up a “Chooz List” of persons being “followed” via the Chooz App. Figure (or screen) numbers 11, 12, and 13 correspond to the individual feeds SM₁, SM₂, and SM₃. Each of these subset displays, 11, 12, and 13 include buttons to access the functions Feeds, Comment, and Chooz, which may link the user to one of the Add or Remove screens at FIGS. 5 and 6, for example. The process depicted in FIG. 19 begins with a CHOOZ step 302 in a user's home screen of his or her smart phone (FIG. 1 in this example) to access a website for launching the App 300 in step 304, from which the user may login at step 306 and sign-up to receive access and download the App 300 at step 308 depicted in FIG. 2. As installed, the App 300 causes a CHOOZ icon 20 to appear in the home screen 12 of the user's device 10 as shown in FIG. 1. If, during the launch step 304 the user decides to logout, the user may select logout at step 310, which may include deleting any portion of the App 300 that was downloaded, followed by execution of a logout process in step 312.

When login and sign-up are completed, the process advances to the screen display of FIG. 3 to synchronize the App 300 installed in the user's device by following prompts at step 320. Links in the App 300 provided by the respective API code for each available social media platform may then be executed, in turn, respectively for social media platforms numbers SM₁, SM₂, and SM₃ in the steps 322, 324, and 326 to interface the functions and attributes provided in the App 300 with the operating system of the user's device 10. These necessary operations are well understood by persons skilled in the programming arts and thus need not be described herein.

Once the Sync steps 320-326 are completed, the user may, as shown in FIG. 4, execute steps to implement an “All Feeds” feature in step 348. This feature configures the App 300 to organize all feeds from the three SMPs into display screen listing of all the feeds from SMP contacts in corresponding lists, one for each SMP, so that the list may be displayed on the screen 12. FIG. 4 illustrates one example for the SMP#3. The lists for the other SMPs are similar as have been described. In step 350, the user may call a “Chooz List” function to display the list of all feeds and identifying those who the user has configured to “follow” or “monitor” with display of the “CHOOZ” logo or icon next the name of each so-configured contact. This step 350 is illustrated in FIG. 10. A feature available in the App 300 from a second “All Feeds” process 368 linked from step 350 provides an opportunity to respond to a contact's feed by entering and sending a comment in step 370. In this way the user may correspond with the contact in the feed directly to the SMP from within the App 300.

Continuing with FIG. 19, the App 300 is prepared to respond to tapping operations by the user to configure the features of the device 10. One novel feature of the App 300 is the ability to specify by entering specific keywords which, when they appear in any feed received from a contact participating in one of the social media platforms, may be highlighted or the user otherwise notified that the entered keyword or keywords are found in the text of the feed. This feature is utilized beginning in step 330 “Keyword,” which links the user to the Add/Remove screen of FIG. 7 in step followed by step 334 to display a “Keyword List” screen as shown in FIG. 8. The operation of the features depicted in FIGS. 7 and 8 were described previously.

The processes depicted for accessing the feeds of each of the three SMPs, SM₁, SM₂, and SM₃, are shown separately in FIG. 19. The screen displays corresponding to the social media platforms SM₁, SM₂, and SM₃ are shown in respective FIGS. 11, 12, and 13. The steps in each case are similar; therefore, one of them will be described. For social media #1 (SM₁), initiated by tapping the icon for SM₁ in step 350 (See FIG. 11, which, when the icon 22 is tapped, the icon 22 is surrounded by a circle), the App 300 lists all of the feeds in step 352. Upon reviewing, the user may respond to the feed at 352 by adding a comment 362 to the feed for the particular contact the user selected by tapping the displayed name and text associated with the contact's post as shown in FIG. 11. Returning to step 350, the user may select step 372 by tapping the Chooz button 84 at the top of the screen 12 to transfer to FIG. 5 or 6 to Add/Remove a contact or feed in step 374, or alternatively to FIG. 14 in step 374 to search for a particular feed or enter additional identifying information to view a new feed, for example.

The processes for the other SMPs also depicted in FIG. 19 are similar: For social media #2 (SM₂) the process begins at step 344 and continues through steps 354, 364, 382, and 384. For social media #3 the process begins at step 346 and continues through steps 356, 366, 392 and 394.

Another subset of FIG. 19 illustrates one sequence of the use of the “Menu” icon 48 that appears in most of the screens illustrated herein. The process begins at step 380 (e.g., in FIG. 15) when the user taps the menu icon 48, which may be followed by step 390 (see FIGS. 16 and 17, respectively to access the processes for “Profile” and “Shop.” From step 390, the user can advance to step 396 (FIG. 17) or step 398 (FIG. 18). When the user taps the menu icon 48 appearing on any screen, it opens to the user profile screen 200 shown in FIG. 15, to provide the user a path to select “Profile” update 202 or “Shop” update 204. The user profile screen 200 may include the user's photo 206 and two lists 208 and 210. The list 208 may include a tally of the number of contacts or contacts the user is following using the App 300. It may also include a tally of the number of keywords 210 entered into the App 300. The menu icon 48 that appears in the lower left portion of FIG. 19 graphically depicts the process flow of this subset associated with the menu icon for servicing the user's account in the App 300.

Continuing with FIG. 19, enclosed within a dashed line box labeled “Data Parsing” in the lower portion of FIG. 19 is a short statement regarding the uses of a data parsing process 400. As described previously, The CHOOZ App 300 receives data feeds from the SMPs (regardless of their number) that are accessed via the respective APIs for the SMPs contained in the App 300. The data parsing process 400 is used as part of the synchronizing the App in the user's mobile device to each SMP so that the user's App 300 may be populated with the feeds and contacts the user desires to follow or monitor. The data parsing process also helps to organize the data of the feeds and contacts such that it may be accessed as needed when an ALL FEEDS 52, SYNC 54, and KEYWORDS 56 button in the left margin (or right margin in FIG. 15) is tapped or touched by the user. Further, the data parsing process 400 is active when setting up the files containing the contacts data and the keyword data. It is also accessed to detect and notify the user of the presence of keywords embedded within the feeds, and to update a contact's data when the contact is active on the SMP.

It will also be appreciated by persons skilled in the art that the sequences depicted in FIG. 19 can be modified to enable following feeds provided by other entities. FIG. 19 is intended to be illustrative and not limited to the particular selection of functions or choices.

Described herein are technical improvements in an apparatus and method for monitoring and following posts of selected contacts on selected multiple social media platforms from a personal wireless device of a user thereof. The App may preferably be installed in a personal wireless mobile device comprising a processor, a non-transitory memory, a wireless interface to a global communications network, and a touch-sensitive display screen for entry of user selections. The App preferably comprises a program stored in the non-transitory memory and configured to respond to the user's entry of icon-selectable commands on the touch-sensitive display screen to control operative sequences performed by the processor in coordinating from within the App including but not limited to (A) synchronizing via downloaded interfaces with certain social media platforms from the user's wireless mobile device to access any or all individual feeds therein so they may be viewed, followed, monitored, etc.; (B) providing direct access to the feeds of individual or across multiple social media platforms produced by all individuals; \textcircled{c} searching the individual feeds for content containing keywords entered into the App by the user; and (D) notification and highlighting of the occurrence of the keywords in the posts of individual feeds.

Restated, the novel functions of the App include at least the following:

synchronizing the personal wireless device, using downloaded interfaces, with the multiple social media platforms to enable interactive access with and aggregation of all of the user's contacts across the social media platforms;

choosing direct access to and interaction with a specified individual contact's feeds from each of, or from all feeds across the multiple social media platforms, for following or monitoring the individual feeds of specified individual contacts thereof;

entry of keywords into a filtering sequence in the program for identifying content in contact's feeds being followed or monitored that is of potential interest to the user of the personal wireless device; and

notification and highlighting of the occurrence of keywords in each social media feed of a contact followed or monitored from the personal wireless device.

While the invention has been shown in only one of its forms, it is not thus limited but is susceptible to various changes and modifications without departing from the spirit thereof. For example, the invention is not limited to wireless mobile devices but may be adapted to fixed devices or devices connected via wired links with social media platforms and the users thereof. Similarly, the invention is not limited to the ability to manage feeds from three social media platforms, because it can handle fewer or more such platforms depending on what is permitted by the platforms and the volume of data, for example. While a touch screen interface is used as an example of a typical personal wireless device, in future technology there may be other types of interfaces that become possible or even more efficient or convenient for the user. Similarly, the types of icons and images that are appropriate for a touch screen display may be replaced by other forms of symbolic representation of functions, commands, or other attributes.

What is claimed is:

1. An apparatus for monitoring and following posts of selected individuals in the feeds of multiple social media platforms from a personal wireless device of a user, the device having a processor, a non-transitory memory, a wireless interface to a global communications network, and a touch-sensitive display screen for entry of user selections, comprising:
a program stored in the non-transitory memory and configured to respond to the user's entry of icon-selectable commands on the touch-sensitive display screen to control operative sequences executed by the processor in controlling, from within the program installed in the personal wireless device, operations including:
synchronizing the personal wireless device, using downloaded interfaces, with the multiple social media platforms to enable interactive access with and aggregation of all of the user's contacts across the social media platforms;
choosing direct access to and interaction with a specified individual contact's feeds from each of, or from all feeds across the multiple social media platforms, for following or monitoring the individual feeds of specified individual contacts thereof;
entry of keywords into a filtering sequence in the program for identifying content in contact's feeds being followed or monitored that is of potential interest to the user of the personal wireless device; and
notification and highlighting of the occurrence of keywords in each social media feed of a contact followed or monitored from the personal wireless device.

2. The apparatus of claim 1, wherein the program includes sequences of process steps, comprising:
synchronizing the program with one or more social media platforms using an application program interface (API) provided by each social media platform;
associating icon-initiated user commands displayed on the display screen of the user device with directing execution of the sequences of process steps;
entering search terms or keywords into a keyword file for retrieval and for controlling searching, notification, and highlighting of the search terms in feeds accessed by the program for display to the user;
enabling additions and deletions of keywords in the keyword file;
providing direct access and interaction with a specified social media platform or across the multiple social media platforms from within the program, for responding thereto or entering content;
providing display screens to display social media feeds of contacts, lists of keywords, lists of chosen contacts, and a keyboard for entering the search terms and chosen contacts;
updating user profile and account status information; and
providing a plurality of housekeeping functions accessible from a menu command.

3. In a personal wireless device comprising a processor, a non-transitory memory, a wireless interface to a global communications network, and a touch-sensitive display screen for entry of user selections, and having a program stored in the non-transitory memory and configured to respond to the user's entry of icon-selectable commands on the touch-sensitive display screen to control operative sequences performed by the processor, a method for following and monitoring posts of selected individuals on and across multiple social media platforms from a personal wireless device, comprising the steps of:
selecting individual feeds from each of the selected social media platforms for monitoring and following posts of specific individual users thereof;
entering keywords into a filtering sequence in the program for identifying subject matter of potential interest to the user of the personal wireless device;
notifying and highlighting the occurrence of keywords in each social media feed of an individual selected to be monitored and followed from the personal wireless device; and
calling a sequence in the program to enable the user of the personal wireless device to be directed to a specific social media platform for replying to an individual being monitored or followed.
